(19) United States
(12) Patent Application Publication
(10) Pub. No.: US 2012/0225585 A1
(43) Pub. Date: Sep. 6, 2012

(54) ELECTRICAL CONNECTOR WITH EQUAL WIDTH CONNECTION PART

(75) Inventors: KUO-CHI LEE, Taipei County (TW); CHIN-HUANG LIN, Taipei County (TW)

(73) Assignee: CONCRAFT HOLDING CO., LTD., Grand Cayman (KY)

(21) Appl. No.: 13/183,504

(22) Filed: Jul. 15, 2011

(30) Foreign Application Priority Data
Mar. 4, 2011 (TW) 100203829

(51) Int. Cl. H01R 24/28

(52) U.S. Cl. 439/626

(57) ABSTRACT

An electrical connector includes a plurality of transmission terminals and an insulation plate. The transmission terminals are g installed in parallel manner relative to one another, and each includes a first end, a second end and an equal-width connection part interconnecting the first end and the second end. The equal-width connection parts have the same width. The insulation plate is disposed among the transmission terminals so as to fix the transmission terminals in position with the first ends and the second ends protruding respectively and outwardly from the insulation plate.

This application claims the benefits of the Taiwan Patent Application Serial No. 100203829 filed on Mar. 4, 2011, the subject matter of which is incorporated herein by reference.

### BACKGROUND OF THE INVENTION

1. Field of the Invention

The present invention relates to an electrical connector, more particularly to an electrical connector having a resilient plate which is compressed upon plug-in action of a foreign connector so as to retract in dimension, thereby accumulating a restoration force tending toward a direction opposite to the plug-in direction of the foreign connector.

2. Description of the Prior Art

Referring to FIGS. 1 and 2, FIG. 1 is a schematic drawing of a conventional electrical connector and FIG. 2 is a partially exploded view of the conventional electrical connector. A conventional electrical connector 100 includes a plurality of transmission terminals 11 and an insulation plate 12.

Each transmission terminal 11 includes an input end 111, an output end 112 and a connection part 113 interconnecting the input end 111 and the output end 112; the width of the connection part 113 varies according to bandings of the transmission terminal 11.

Further, the insulation plate 12 is disposed among the transmission terminals so that the transmission terminals are not electrically connected to one another.

However, since the width of the connection part 113 is not equal, reflections and attenuations are easily caused during transmissions of electrical signals. Furthermore, chips tend to misinterpret electrical signals so that the accuracy of interpretation for signals is decreased.

### SUMMARY OF THE INVENTION

The present invention relates to an electrical connector, more particularly to an electrical connector including a plurality of transmission terminals, each of which has equal width connection part so as to decrease reflections and attenuations caused during transmissions of electrical signals.

An electrical connector is provided, including a plurality of transmission terminals and an insulation plate; each transmission terminal being installed in parallel and including a first end, a second end and an equal width connection part interconnecting the first end and the second end, the width of the connection part in each transmission terminal being equal; the insulation plate being disposed among the transmission terminals so as to fix the transmission terminals with the first ends and the second ends protruding from the insulation plate.

According to an embodiment of the present invention, each of the equal width connection parts of each of the transmission terminals includes a bending section, opposite two sides of the bending section being a horizontal section and a vertical section; furthermore, the insulation plate includes a first sub-plate disposed among the horizontal sections of the transmission terminals; and a second sub-plate disposed among the vertical sections of the transmission terminals.

Compared with the conventional electrical connector, since the width of the equal width connection part of the transmission terminal are equal, reflections and attenuations caused during transmissions of electrical signals are effectively avoided; furthermore, the accuracy for chips to interpreting electrical signals is improved.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a schematic drawing of a conventional electrical connector;

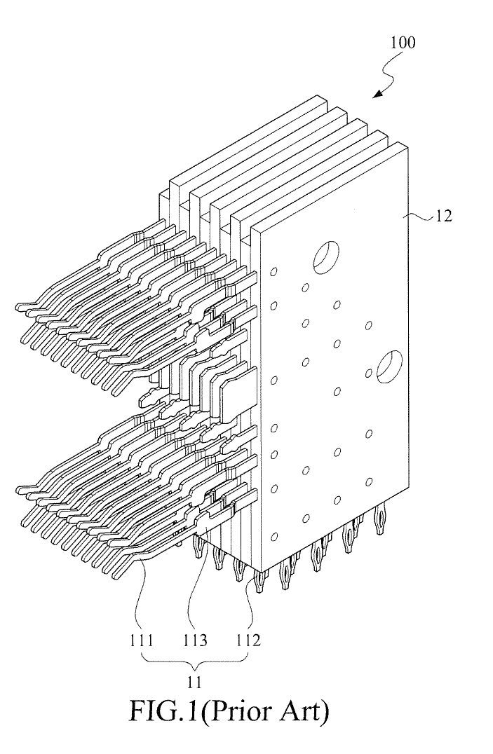

FIG. 2 is a partially exploded view of the conventional electrical connector;

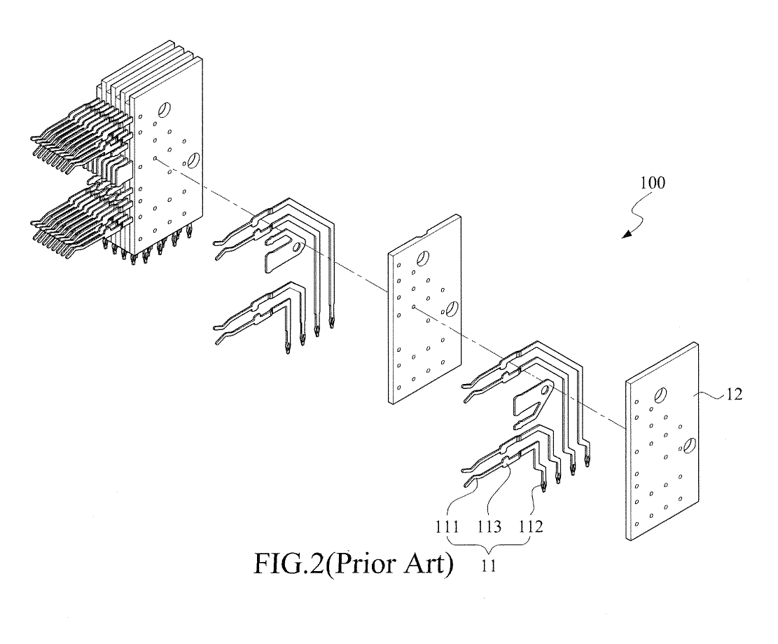

FIG. 3 is a schematic drawing of a preferred embodiment of an electrical connector according to the present invention; and

FIG. 4 is an exploded view of the preferred embodiment of the electrical connector according to the present invention.

### DETAILED DESCRIPTION OF THE PREFERRED EMBODIMENT

The present invention relates to an electrical connector, more particularly to an electrical connector including a plurality of transmission terminals, each of which has equal width connection part. A preferred embodiment of the electrical connector of the present invention is disclosed in the following paragraphs for better understanding of the present invention. However, the scope of the present invention should not be limited only to the structure of the disclosed embodiment

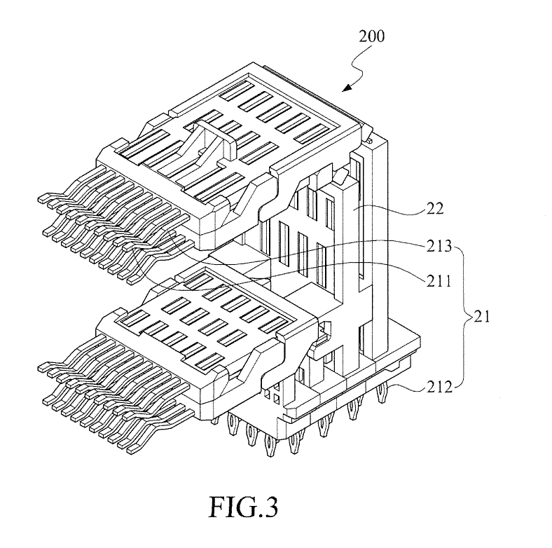

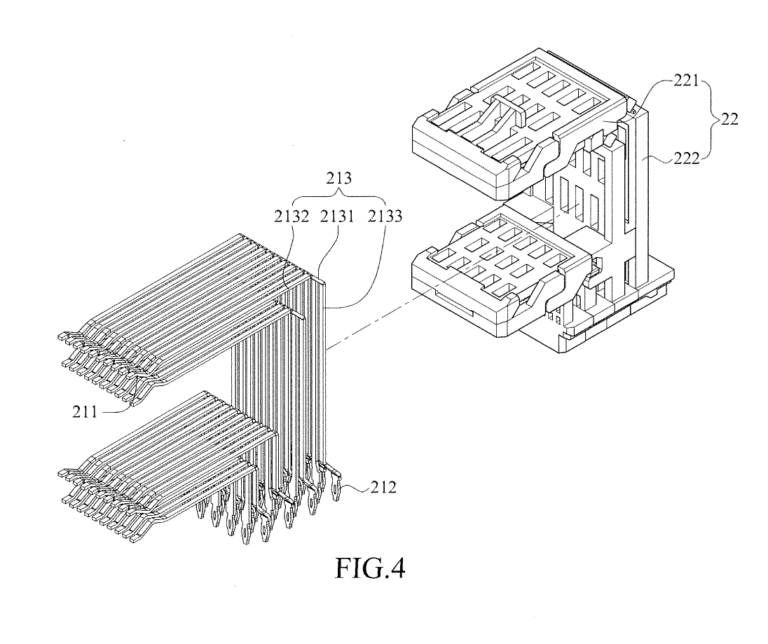

Referring to FIGS. 3 and 4, FIG. 3 is a schematic drawing of a preferred embodiment of an electrical connector according to the present invention while FIG. 4 is an exploded view of the preferred embodiment of the electrical connector according to the present invention. According to the preferred embodiment of the present invention, an electrical connector 200 is provided, includes a plurality of transmission terminals 21 and an insulation plate 22; the transmission terminals 21 are being installed in parallel manner and each includes a first end 211, a second end 212 and an equal-width connection part 213 interconnecting the first end and the second end. The width of the connection part 213 in one transmission terminal 21 is equal to (the same as) that of another transmission terminal 21.

The insulation plate 22 is disposed among the transmission terminals 21 so as to fix the transmission terminals 21, the first ends 211 and the second ends 212 of the transmission terminals 21 protrude respectively outward from the insulation plate 22.

According to an embodiment of the present invention, each of the equal-width connection parts 213 of the transmission terminals 21 includes a bending section 2131, opposite two sides of the bending section being a horizontal section 2132 and a vertical section 2133. Furthermore, the insulation plate 22 includes a first sub-plate 221 disposed among the horizontal sections 2132 of the transmission terminals 21; and a second sub-plate 222 disposed among the vertical sections 2133 of the transmission terminals 21.

Of course, the insulation plate 22 may include more than one transmission terminal 21 in real practice. According to FIGS. 3 and 4, besides the transmission terminals 21, the electrical connector of the present invention further includes another three sets of transmission terminals of different shapes. As long as the width of the connection part in one e transmission terminal is equal to the width of the connection part of another transmission terminal, reflections and attenuations caused during transmissions of electrical signals are effectively avoided; furthermore, the accuracy for chips to interpreting electrical signals is improved.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electrical connector comprising:
a plurality of transmission terminals, the transmission terminals being installed in parallel manner, each transmission terminal including:
a first end;
a second end; and
an equal-width connection part interconnecting the first end and the second end, the width of the equal-width connection part being equal; and
an insulation plate disposed among the transmission terminals so as to fix the transmission terminals in position such that the first ends and the second ends of the transmission terminals protrude respectively and outwardly from the insulation plate.

2. The electrical connector according to claim 1, wherein each of the equal width connection parts of the transmission terminals includes a bending section, opposite two sides of the bending section being a horizontal section and a vertical section.

3. The electrical connector according to claim 2, wherein the insulation plate includes:
a first sub-plate disposed among the horizontal sections of the transmission terminals; and
a second sub-plate disposed among the vertical sections of the transmission terminals.
